(19) United States
(12) Patent Application Publication
(10) Pub. No.: US 2024/0193023 A1
(43) Pub. Date: Jun. 13, 2024

(54) PREDICTING THE IMPACT OF PREVIOUSLY UNSEEN COMPUTER SYSTEM FAILURES ON THE SYSTEM USING A UNIFIED TOPOLOGY

(71) Applicant: INTERNATIONAL BUSINESS MACHINES CORPORATION, Armonk, NY (US)

(72) Inventors: Avirup Saha, Kolkata (IN); Renuka Sindhgatta Rajan, Bengaluru (IN); Neelamadhav Gantayat, Bangalore (IN); Sampath Dechu, Acton, MA (US); Ravi Shankar Arunachalam, Bangalore (IN); Sachindra Joshi, Gurgaon (IN)

(21) Appl. No.: 18/064,069

(22) Filed: Dec. 9, 2022

(51) Int. Cl. G06F 11/00; G06F 9/54

(52) U.S. Cl. CPC G06F 11/004; G06F 9/54; G06F 2201/86

(57) ABSTRACT

Predicting the impact of an information technology (IT) failure includes detecting a computer-generated indication of the failure. Responsive to determining that the IT failure is a previously unseen IT failure, operations of a computer-implemented unseen event handler can be invoked. The unseen event handler can map the previously unseen IT failure to a previously seen IT failure based on a similarity score generated by a computer-implemented similarity scorer, wherein the similarity score is based on a unified process-IT topology. A machine learning model can generate an IT failure impact prediction and recommendation based on the mapping, wherein the machine learning model also is based on the unified process-IT topology. An output of the IT failure prediction and recommendation can be generated.

### BACKGROUND

This disclosure relates to information technology (IT) systems and, more particularly, to predicting the impact of previously unencountered technology failures related to such systems.

Enterprises, such as business organization and governmental entities of all sizes, increasingly rely on IT to automate various processes. A business organization, for example, may rely on IT to implement an automated process whereby orders for a product are electronically received, validated, and processed for shipment of the product. Once a product is shipped, the business organization may use IT-implemented tracking of the shipment and for processing payment for the product. Given the business organization's reliance on IT to implement the process, any IT failure that interrupts or delays the process can be very costly, both as to revenue and the business' reputation. It can be critical that an enterprise detect and respond rapidly and accurately to an IT failure.

An enterprise's ability to detect and evaluate the impact of previously unseen information technology (IT) failures, however, can be especially difficult for various reasons. One reason is that process owners and IT operations teams typically work in separate silos. The process owners and IT operations team often lack a single, unified view of the enterprise processes that are implemented with, and supported by, an underlying IT system. The IT system of even a moderately sized enterprise may perform several hundred processes and execute several thousand applications for automating the processes. Thus, manually creating linkages among the various facets of the IT system is extremely challenging. Such linkages can be cumbersome, subject to error, and may quickly become obsolete. Moreover, certain IT errors, especially rare ones, may not be detected or observed. Some may be ignored. Notwithstanding, these challenges, an enterprise can ill afford to ignore the impact of IT errors. As already noted, the impact of IT failures on an enterprise can be considerable.

### SUMMARY

In one or more embodiments, a method includes detecting, with computer hardware, a computer-generated indication of an information technology (IT) failure affecting a process performed by an IT system. The method includes determining, with the computer hardware, that the computer-generated indication corresponds to a previously unseen IT failure. The method includes mapping, with the computer hardware executing an unseen event handler, the previously unseen IT failure to a previously seen IT failure based on a similarity score generated by a computer-implemented similarity scorer. The method includes generating, with a machine learning model, an IT failure impact prediction and recommendation based on the mapping, wherein the machine learning model is based on a unified process-IT topology. The method includes outputting, with the computer hardware, the IT failure prediction and recommendation.

In one aspect, the unified process-IT topology is created by determining key entities of a plurality of steps of the process performed by the IT system, by grouping a plurality of application program interface (API) calls based on payload and temporal proximities of the API calls, extracting key entities for corresponding service APIs, aligning the steps of the process with service APIs, determining key service APIs for the process steps, and generating the unified process-IT topology based on a retrieved infrastructure that implements the service APIs.

In another aspect, a Hierarchical Dirichlet Gaussian Marked Hawkes Process is used in creating the unified process-IT topology.

In another aspect, generating the IT failure forecast and recommendation can include extracting a resolution history corresponding to the previously seen IT failure and including the resolution history in the IT failure forecast and recommendation.

In another aspect, the computer-generated indication can comprise a previously unseen IT alert, which maps to a current-environment IT alert corresponding to the previously seen IT failure. Implementing a machine learning model, an IT failure impact forecast and recommendation can be generated by extracting parameters of the current-environment IT alert and inputting the parameters to the machine learning for generating the IT failure impact forecast based on the parameters.

In another aspect, the computer-generated indication can comprise a previously unseen IT alert, which maps to an IT alert retrieved from an external environment. With a machine learning model, an IT failure impact forecast and recommendation can be generated by invoking a severity estimator to generate an estimated severity of impact on the IT system.

In another aspect, the computer-generated indication can comprise a KPI impact or change in value that is detected as possible IT failure without having observed any IT alerts. With a machine learning model, an IT failure impact forecast and recommendation can be generated by identifying a likely IT failure in response to the KPI impact. A database search can be performed to match the KPI impact with an existing impact profile corresponding to a previously seen IT failure, wherein the matching is based on statistical correlation.

In one or more embodiments, a system includes a processor configured to initiate executable operations as described within this disclosure.

In one or more embodiments, a computer program product includes one or more computer readable storage mediums having program code stored thereon. The program code is executable by a processor to initiate executable operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an information technology failure (ITF) impact prediction framework.

FIG. 2 illustrates an example architecture for the executable ITF impact prediction framework of FIG. 1.

FIG. 3 illustrates an example method of operation of the ITF impact prediction framework of FIGS. 1 and 2.

FIG. 4 illustrates an example of the mapping of an unseen IT failure and the generation of an impact prediction and recommendation as performed by the unseen event handler of the example architecture of FIG. 2.

FIG. 5 illustrates an example of the key performance indicator (KPI) mapping and the impact prediction and recommendation generation as performed by the unseen event handler and impact profile matching engine of the example architecture of FIG. 2.

FIG. 6 illustrates an example of the generation of a unified process-IT topology as performed by the unified topology generator of the example architecture of FIG. 2.

FIG. 7 illustrates an example process IT combination for which an example unified process-IT topology is generated by the unified topology generator of the example architecture of FIG. 2.

FIG. 8 illustrates portions of the example unified process-IT topology generated by the unified topology generator of the example architecture in FIG. 7.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to IT systems and, more particularly, to predicting the impact of previously unencountered technology failures related to such systems. As noted above, enterprises (e.g., businesses, governmental, and other entities) of all sizes increasingly rely on IT systems to carry out a wide array of activities, and accordingly, it can be critical that, when an IT failure occurs, the enterprise utilizing the system responds rapidly and accurately to the IT failure. An optimal response, however, requires that the enterprise have at least some awareness of the root cause and future impact of the IT failure. If the IT failure is one not previously seen, however, it may be very difficult for the enterprise to learn the root cause or future impact of the IT failure.

In accordance with the inventive arrangements described within this disclosure, methods, systems, and computer program products are provided that are capable of determining the impact of an unseen IT failure based on a unified process-IT topology. “Unified process-IT topology,” as defined herein, is a description of the interrelationship among the steps of a defined process, such as a business process (e.g., insurance claim processing), and specific IT events (e.g., API calls) executed by an IT system in performing automated functions that carry out the process steps. As defined herein, “IT event” is an automated action, process, or function performed by an IT system. For example, many IT events include an API call, which instantiates or invokes the action, process, or function. As defined herein, “IT failure” is a machine-generated error that causes a result that is incorrect, unintended, or less optimal than expected by an IT system user or causes a cessation of all or a portion of the processes executed by the IT system. Thus, the error can affect an automated function performed by the IT system, and accordingly, can cause a corresponding failure or suboptimal performance of the process step supported by the automated function. “Unseen IT failure,” as defined herein, is an IT failure that the IT user has not previously encountered and has no, or only limited, current knowledge of.

By aligning and linking IT events with the steps of a process that the IT system supports into a unified topology, the inventive arrangements herein can detect and predict the impact of an IT failure on the process or processes supported by the IT system. An example of a process is a business process as performed using IT infrastructure such as data processing systems and networked data processing systems. As defined herein, the IT infrastructure is the software architecture that operatively combines software elements (e.g., IT services and applications) that perform specific actions, processes, and functions, as well as the computer hardware on which the software elements are executed. The unified process-IT topology is based on the integration of the process steps and the various IT services and applications of an IT infrastructure that support a process. The inventive arrangements may be used, for example, to determine the impact of an unseen IT failure on key performance indicators (KPIs) corresponding to the process. Determination of the IT failure's impact (e.g., on one or more process KPIs) can dictate a redeployment and/or reconfiguration of IT resources using IT site reliability engineering (SRE) techniques, thereby mitigating the impact of an IT failure. The inventive arrangements can discover a likely root cause of the IT failure, as well as extract resolution histories that effectively and efficiently dealt with previously seen IT failures that are similar. The resolution histories, as applicable, can be integrated into a set of predictions and recommendations generated by the inventive arrangements for remedying the unseen IT failure, or at least lessening its impact. In the specific context of business processes supported by an IT system, for example, the more rapidly and accurately an IT failure is diagnosed and corrected, the less likely is a loss of business and/or loss in revenues.

In one aspect, the inventive arrangements overcome challenges to generating a unified topology for a process (e.g., business process) and the IT supporting the process. One challenge is that process logs and IT logs are generated at different stages of the process. For example, process logs record performance of the steps of the process and are generated after execution of the API calls and other IT events, which typically are logged in real, or near-real, time in an IT log separate from the log of process step. Both the process log and IT log, moreover, typically use different data structures and terminologies for the same or similar event. Another challenge is asynchronous process execution, in which different event instantiations occur at different stages, thus precluding or limiting temporal clustering and making it difficult to achieve a one-to-one correspondence between process steps and corresponding API calls and/or other IT events. Business processes, moreover, often have parallel process paths that are asynchronous. For example, a process for handling insurance claims may entail two simultaneous steps—customer verification and claim amount verification—that are independent and asynchronous in nature. Yet another challenge is in linking API calls and process logs owing to terminology differences (e.g., API names are typically very generic), which precludes or limits using semantic similarity to link and align API names and process steps. The data contained within an API call (the payload) also may lack sufficient detail for linking the API call and process log.

The unified process-IT topology introduced in the inventive arrangements disclosed herein overcomes these challenges. In one aspect, the unified process-IT topology provides a local clustering for grouping events (API calls with process log entries) related to the same process step, and a higher-level (global) clustering for grouping, as feasible, local clusters in both the IT and event streams. Global clustering provides a second-order clustering into groups that contain local clusters from both domains. In another aspect, the unified process-IT topology combines temporal and semantic (event-related) features. Temporal features enable the grouping of events from different streams with large time differences in the same global cluster, notwithstanding large time lags between events recorded in both IT and process logs. Moreover, the local and global clustering can encompass continuous (e.g., real) time as well as, or alternatively to, discrete time. A combined and flexible approach to clustering of multi-event streams in continuous time is an aspect largely lacking with conventional process monitoring and IT monitoring, especially in the context of combining the two.

In another aspect, the inventive arrangements assess the impact of IT failures. An observed but previously unseen IT failure's impact can be assessed based on the uniform process-IT topology.

In yet another aspect, an unobserved IT failure can be assessed based on impact profile matching. The profile matching can determine the likely root cause and future impact of the IT failure.

In still another aspect, the inventive arrangements can recommend one or more remediations to mitigate or lessen the impact of the IT failure.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

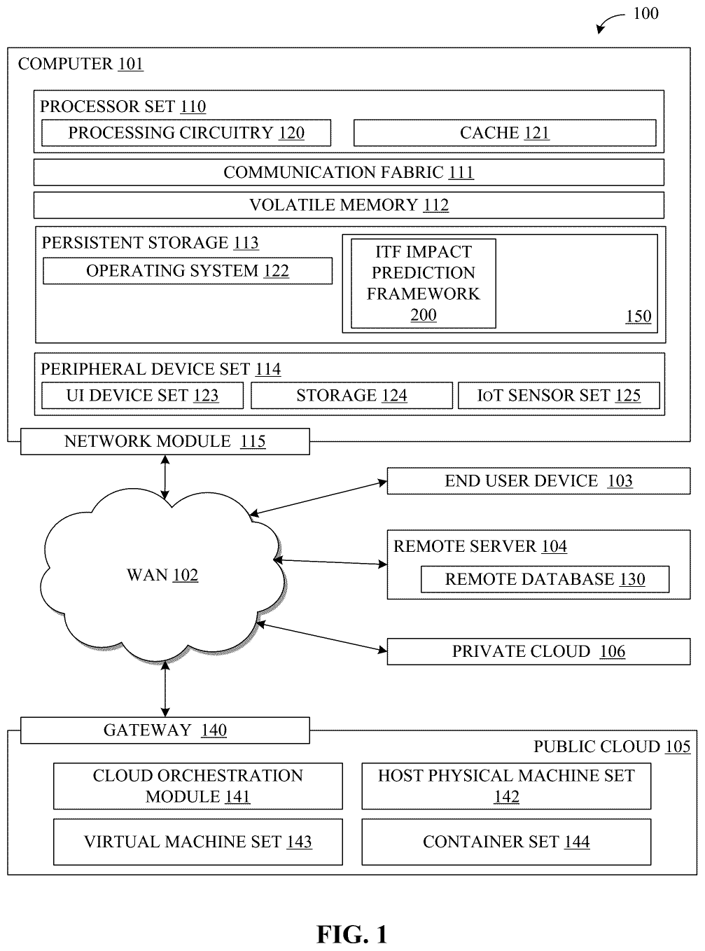

Referring to FIG. 1, computing environment 100 contains an example of an environment for the execution of at least some of the computer code in block 150 involved in performing the inventive methods, such as information technology failure (ITF) impact prediction framework 200 implemented as executable program code or instructions. ITF impact prediction framework 200 is capable of determining the impact of unseen IT failures based on a unified process-IT topology. Determination of the impact on one or more process KPIs, for example, can dictate a redeployment and/or reconfiguration of IT resources using IT SRE techniques, which can avoid or mitigate a loss of business and/or revenues. With the ITF impact prediction framework 200, a likely root cause of the IT failure can be discovered and resolution histories from previously seen IT failures extracted for remedying or limiting the impact of the unseen IT failure.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ITF impact prediction framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

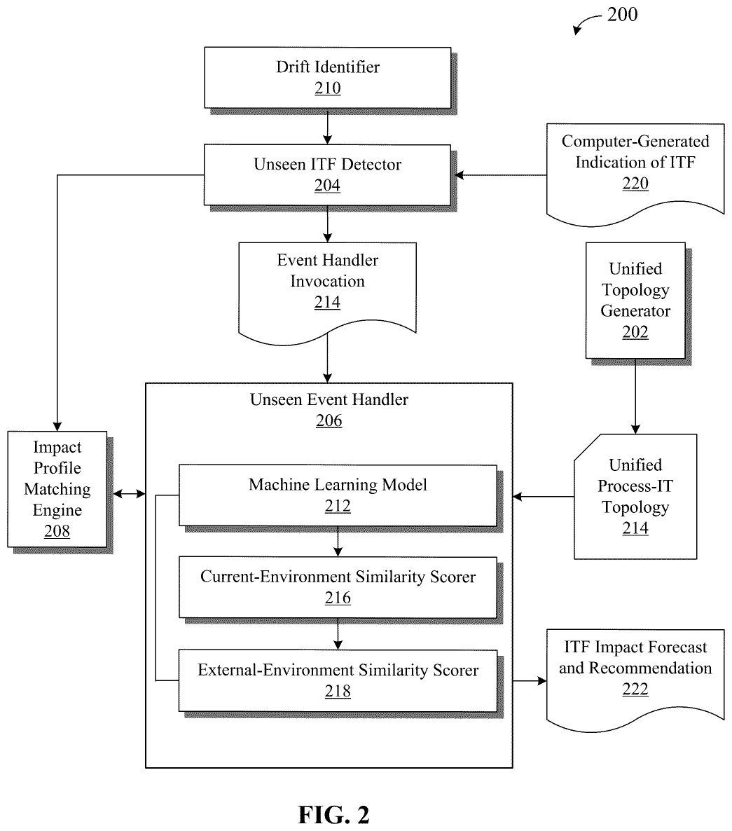

FIG. 2 illustrates an example architecture for the executable ITF impact prediction framework 200 of FIG. 1. Illustratively, in FIG. 2, the example architecture of ITF impact prediction framework 200 includes unified topology generator 202, unseen ITF detector 204, unseen event handler 206, and impact profile matching engine 208. The example architecture of ITF impact prediction framework 200 optionally includes drift identifier 210. In certain arrangements, unseen event handler 206 implements machine learning model 212. Machine learning model 212 is trained based on unified process-IT topology 214, which is generated by unified topology generator 202. Additionally, in certain arrangements, unseen event handler 206 also implements current-environment similarity scorer 216 and external-environment similarity scorer 218.

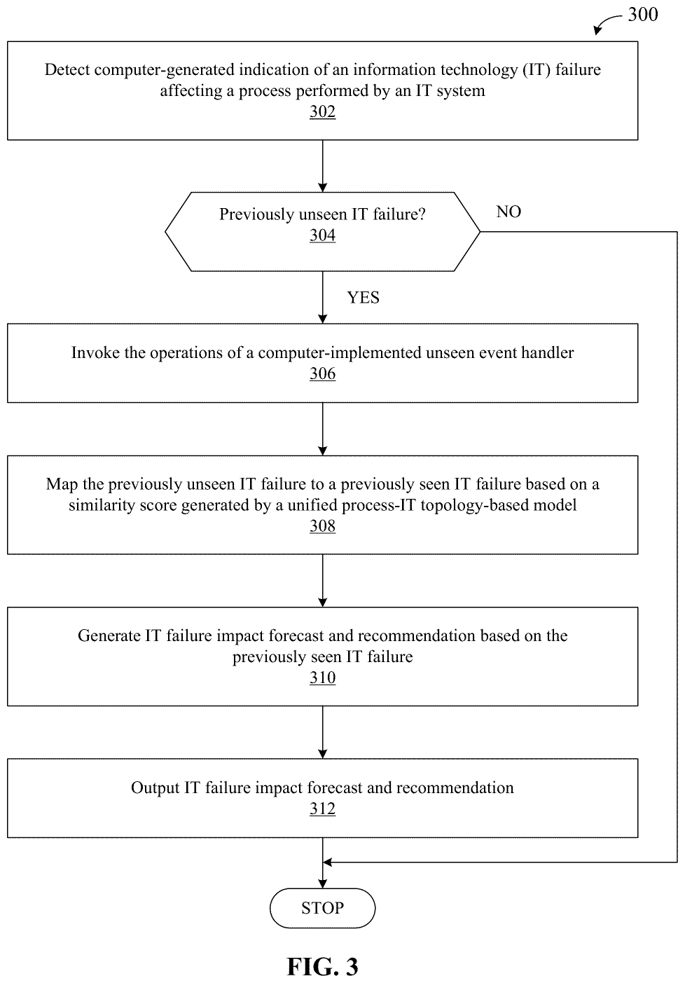

FIG. 3 illustrates an example method 300 of operation of the ITF prediction framework 200 of FIGS. 1 and 2. Referring to FIGS. 2 and 3 collectively, in block 302, unseen ITF detector 204 detects computer-generated indication 220. Computer-generated indication 220 can be generated by a computer or other device that is part of an IT system, such as an enterprise IT system, to which unseen ITF detector 204 is communicatively coupled via a wired or wireless connection. The computing device can generate computer-generated indication 220 in response to a failure of one or more IT services, IT applications, or other elements of an IT infrastructure.

In block 304, unseen ITF detector 204 is capable of determining whether the IT failure indicated by computer-generated indication 220 is one previously encountered by the affected IT system or is otherwise known to the system. In certain arrangements, unseen ITF detector 204 determines whether the IT failure is a previously seen IT failure by automatically searching a database that electronically stores data corresponding to previously seen IT failures. The data can comprise a data structure that records certain parameters corresponding to the previously encountered IT failure. If unseen ITF detector 204's automatic database search fails to detect a match or similarity between a previously encountered IT failure and that indicated by computer-generated indication 220 in block 304, then in block 306, unseen ITF detector 204 invokes operations of unseen event handler 206 via unseen event handler invocation 214.

In block 308, unseen event handler 206 is capable of mapping the previously unseen IT failure to a previously seen IT failure. Unseen event handler 206 maps the previously unseen IT failure to the previously seen IT failure based on a similarity score. Depending on circumstances described below, the similarity score is generated by either current-environment similarity scorer 216 or external-environment similarity scorer 218. Both current-environment similarity scorer 216 and external-environment similarity scorer 218 compute a similarity score using the same procedure but with reference to different databases.

In certain embodiments, current-environment similarity scorer 216 and external-environment similarity scorer 218 can be configured to generate a vector for an IT alert, the vector based on the attributes (context) of the error, such a HTTP error, database error, or server-down condition, for example, as well as other attributes of the IT infrastructure. The similarity between two IT alerts is based on a vector representation of the respective IT systems impacted. The elements of each vector representation of an IT alert correspond to a specific IT system attribute (e.g., database, application instance), each element having a value of one if the IT system attribute is present or a zero value otherwise. A weighted dot product of the vectors is computed. The similarity score is determined by the cosine similarity between the vectors. Weights are relatively higher for a current-environment score than for an external-environment score. Unseen event handler 206 maps computer-generated indication 220 to the previously seen IT failure corresponding to an IT alert having the greatest similarity score. That is, the greatest similarity corresponds to the highest cosine similarity between the vector representation the previously unseen IT alert and the vector representation of the previously seen IT alert corresponding to the previously seen IT failure.

In block 310, machine learning model 212 is capable of generating IT failure impact prediction and recommendation 222. Machine learning model 212 generates the IT failure impact prediction and recommendation 222 based on the previously seen IT failure having the greatest similarity score. In certain arrangements, machine learning model 212 generates the IT failure impact prediction and recommendation 222 using as input the parameters of the previously seen IT failure. Machine learning model 212 is trained to predict an impact of the IT failure, and based on the predicted impact, recommend one or more actions to avoid or mitigate the impact of the IT failure.

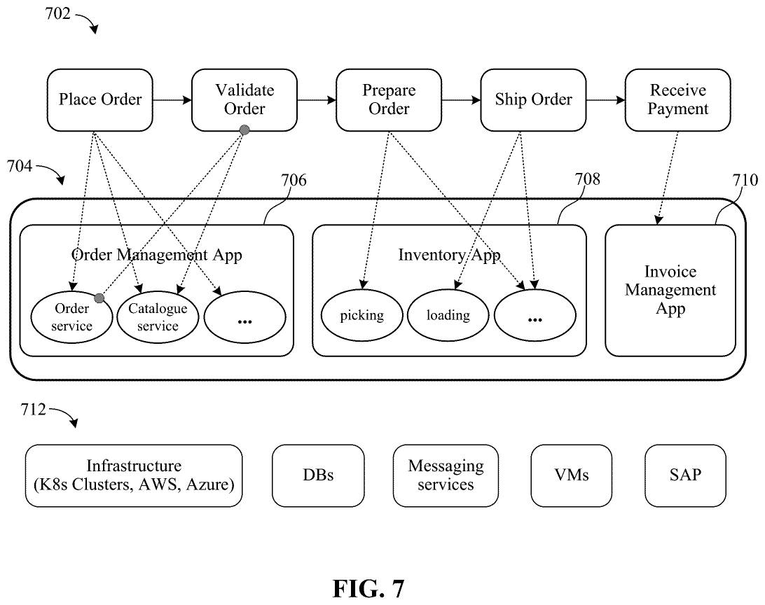

In certain embodiments, machine learning model 212 is a probabilistic model or a deep learning neural network that is trained to associate, based on unified process-IT topology 214, likely impact of the IT failure on one or more processes and/or one or more specific process steps. Unified process-IT topology 214, as described in greater detail below, clusters steps from a process into distinct groups and matches—both temporally and semantically (event-related)—each of the clusters or groups with specific IT events (e.g., API calls) of the IT system that support the process steps. For example, the one or more processes may be a business process supported by an enterprise IT system that is adversely affected by a failure of the enterprise IT system (see, e.g., FIG. 7). The impact of the IT failure predicted by machine learning model 212 can pertain to a specific process step or steps that are likely to be affected by the IT failure and how each process step is likely to be affected. In some embodiments, the prediction is likely change in one or more KPIs that measure performance of the process, the change due to the IT failure. An example machine learning algorithm used for clustering using both temporal and semantic similarities is the Hierarchical Dirichlet Gaussian Marked Hawkes Process, described in greater detail below.

Impact profile matching engine 208, in some embodiments, matches computer-generated indication 220 to an impact profile of a previously seen IT failure having the greatest similarity score. The similarity between KPI impacts of two IT alerts can be determined based on a statistical correlation, whereas to the determination of IT alert similarity is based on impacted IT system attributes. Thus, a matching is applicable to both KPI impact as well as IT failures though the matching process can be implemented differently.

The impact profile can include a root cause analysis (RCA) that corresponds to the previously seen IT failure and that, based on the determined similarity, has applicability to the unseen IT failure. The RCA can be included in IT failure impact prediction and recommendation 222. Remedial actions that proved successful in correcting or mitigating the effect of the previously seen IT failure can also be included in the impact profile identified by impact profile matching engine 208. The remedial actions likewise can be incorporated in IT failure impact prediction and recommendation 222.

In block 312, unseen event handler 206 outputs IT failure impact prediction and recommendation 222.

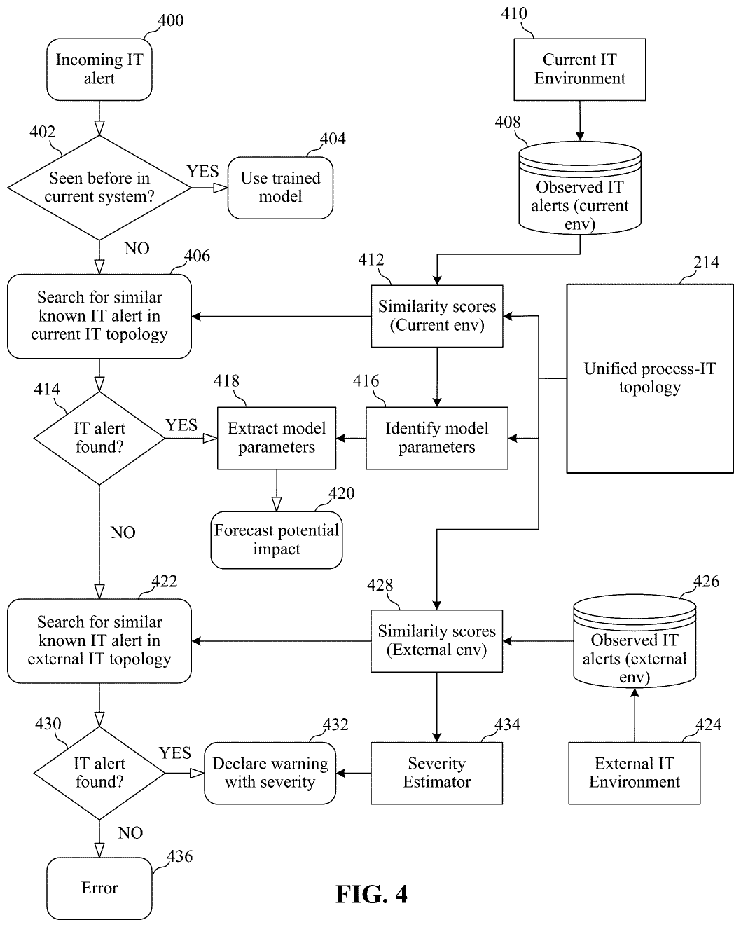

FIG. 4 illustrates an example of the mapping of an unseen IT failure and the generation of an IT failure impact prediction and recommendation as performed by unseen event handler 206. In the example of FIG. 4, unseen ITF detector 204 has determined that the IT failure indicated by computer-generated indication 220 is an IT alert, shown as incoming IT alert 400. In block 402, unseen ITF detector 204 determines whether IT alert 400 is a previously seen IT alert. If so, then in block 404, a trained model (not shown) is used to identify the corresponding IT failure and generate an appropriate response (impact prediction and recommendation).

If in block 402, unseen ITF detector 204 determines that IT alert 400 is a previously unseen IT alert, then in block 406 unseen event handler 206 searches for a similar, known (previously seen) IT alert given the current IT topology (unified process-IT topology 214) generated by unified topology generator 202. The search is for an IT alert, previously observed and electronically stored in a database of observed IT alerts 408, which correspond to current IT environment 410. Current IT environment 410 comprises the various IT services, applications, and other software elements of the infrastructure that collectively support one or more processes used by the entity, such as business or governmental entity, that operates the underlying IT system. The search at block 406 is based on similarity scores 412 of observed IT alerts 408 with respect to IT alert 400, the similarity scores generated by current-environment similarity scorer 216 of unseen event handler 206.

If at block 414 unseen event handler 206 finds a previously seen IT alert, then unseen event handler 206 in block 416 identifies model parameters associated with the previously seen IT alert for input to machine learning model 212 for predicting the impact of the underlying IT failure. Machine learning model 212 can be implemented by a vector autoregression, XGBoost, long short-term memory (LSTM) neural network, or other machine learning algorithm. Machine learning model 212 predicts the impact of the IT alert on the KPIs. The model parameters of the machine learning model are numbers, tensors, numerical weights, or biases that define the machine learning model. In the present context, the model parameters are inherited from models trained using previously seen alerts because no data is available for training a model for an unseen alert. The inherited model parameters are the ones identified in block 416

In block 418, the parameters of the previously seen IT alert are extracted from the previously seen IT alert and input to machine learning model 212 of unseen event handler 206 for forecasting the impact of the previously unseen incoming IT alert 400. Thus, in block 420, unseen event handler 206 predicts the potential impact based on the parameters obtained from the previously seen IT alert determined to be similar. For example, a parameter of the previously seen IT alert that indicates how long a corresponding IT failure is likely to last and which process steps are affected (based unified process-IT topology 214) can enable machine learning model 212 to predict how long a similar failure is likely to last, which steps are affected, and accordingly, how long until those steps of the process can resume.

If at block 414, unseen event handler 206 fails to find a previously seen IT alert, then unseen event handler 206 in block 422 searches for a similar known (previously seen) IT alert from an external environment. An external environment includes any IT services, applications, software infrastructure elements, and the like, other than that currently utilized by the enterprise whose processes run on the IT system affected by the IT failure. For example, if the enterprise operates using one set of enterprise or other software, then that defines the internal environment, and any different set of enterprise or other software is therefore an external environment.

Thus, not having found a current-environment IT alert, unseen event handler 206 searches for IT alerts from external IT environment 424, the IT alerts built on information available from the other environments. A database of observed IT alerts 426 from the external environment is searched by unseen event handler 206. Unseen event handler 206 performs the search based on similarity scores 428 of observed IT alerts 426 with respect to IT alert 400. If in block 430, a similar previously seen IT alert is found by unseen event handler 206, then at block 432, unseen event handler 206 declares a warning indicating a specified severity. The severity can be determined by severity estimator 434. Severity estimator 434 determines the severity based on the parameters of the similar previously seen IT alert. Severity estimator 434 measures the degree to which an IT alert, which occurred as a result of the previously seen IT failure, impacts the KPI(s). Accordingly, if a similar IT alert is found based on the external-environment similarity score, then the severity estimate can be given based on the observed KPI impact (e.g., high/medium/low) within the external environment. A severity estimate is used in instances in which unseen event handler 206 resorts to the external environment, essentially because the external environment cannot provide inheritable model parameters since KPI values may be different. If at block 430, no similar previously seen IT alert is found, then unseen event handler 206 outputs error 436.

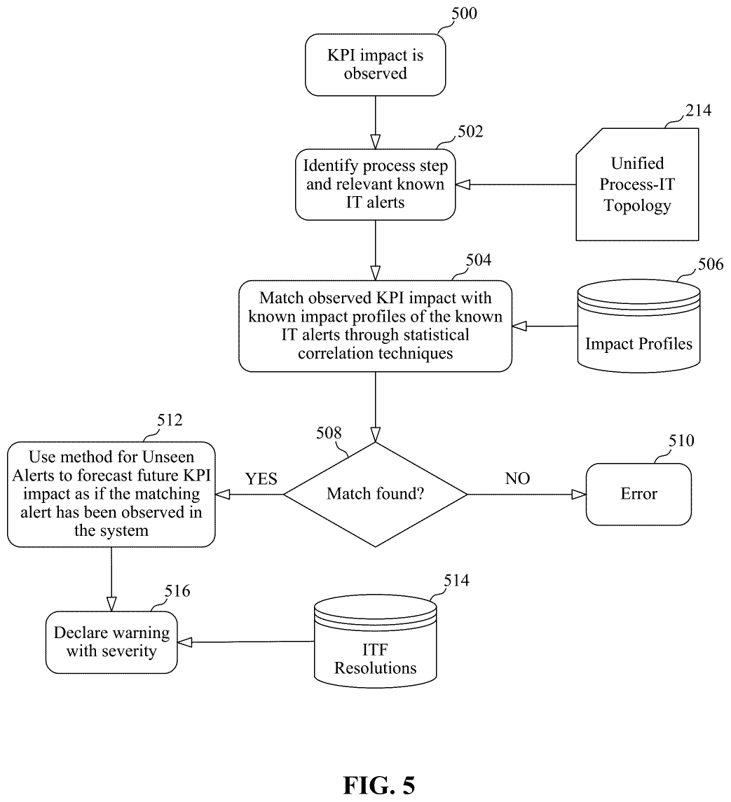

FIG. 5 illustrates an example of operations performed by unseen event handler 206 and impact profile matching engine 208 in response to the computer-generated indication 220 corresponding to a KPI impact. The KPI impact is an adverse change in a KPI (e.g., a reduction in the value of the KPI by a predetermined or threshold amount) of a process. Accordingly, KPI impact indicates a deterioration in execution of the process. The KPI impact can imply or indirectly indicate an IT failure even though there is no observable indication of the IT failure itself. Unseen ITF detector 204, nonetheless, can discern an otherwise unobservable IT failure by detecting the KPI impact. For example, unseen ITF detector 204 may identify a sharp drop (e.g., greater than 20 percent decline) in a KPI that measures the percentage of online payments received by an enterprise as an indication that an invoice management application has failed even though the IT system has not generated an IT alert. ITF impact prediction framework 200 provides an accumulation of information for a wide range of IT alerts and failures from a variety of sources. Unified process-IT topology 214 aligns and links the different IT alerts and failures to the steps of one or more processes (e.g., real-world business processes) and their KPI impact profiles. A KPI impact profile of an IT alert can indicate which KPIs are impacted by the IT alert (e.g. daily sales volume), quantify the impact (e.g. the percentage drop in sales) and specify the duration of impact (e.g. how long the period of low sales lasted before re-attaining normal levels).

In response to a KPI impact, impact profile matching engine 208 operates to detect a match between an impact profile of the KPI impacted and a known IT alert. The match by impact profile matching engine 208 can be based on statistical correlation between the KPI impacted and parameters of the impact profile of each of a plurality of known IT alerts.

In block 500 of the example of FIG. 5, unseen ITF detector 204 observes a KPI impact. Based on unified process-IT topology 214, impact profile matching engine 208 in block 502 identifies one or more relevant IT alerts with a process step whose performance is measured by the KPI whose impact is observed. Impact profile matching engine 208, in block 504, matches the observed KPI impact with impact profiles of known IT alerts by searching a database of impact profiles 506. The identification by impact profile matching engine 208 can be made using statistical correlations techniques that assess the strength of association between the KPI and parameters of the IT alerts. If, in block 508, no statistical correlation greater than a predetermined threshold (e.g., 85 percent confidence) is detected, then impact profile matching engine 208 outputs error 510.

If, in block 508, impact profile matching engine 208 determines a match, then the operations of unseen event handler 206 are automatically invoked in block 512. In block 512, unseen event handler operates as though the KPI impact were a previously unseen IT failure. Thus, once a matching known IT alert is identified by impact profile matching engine 208, unseen event handler 206 can perform the above-described operations (FIGS. 2-4) to generate ITF impact prediction and recommendation 222, albeit in response to, and based on, the observed KPI impact. Event handler 206, in certain embodiments, retrieves from a database of ITF resolutions 514, certain recommendations and/or actions used previously in response to an IT failure corresponding to the IT alert matched to the observed KPI impact. ITF resolutions 514 can comprise resolution history 516 for resolving the matched IT alert. Resolution history 516 can include an RCA and other insights, which can be used to apply IT SRE techniques for rapidly and accurately resolving the IT failure that caused the observed KPI impact. The IT failure would otherwise have been unobserved. By identifying the IT failure in response to and based on the KPI impact, the effect of the IT failure can be alleviated or mitigated. In the context of business processes, for example, this rapid and effective resolution can avoid or lessen losses in business and/or revenues.

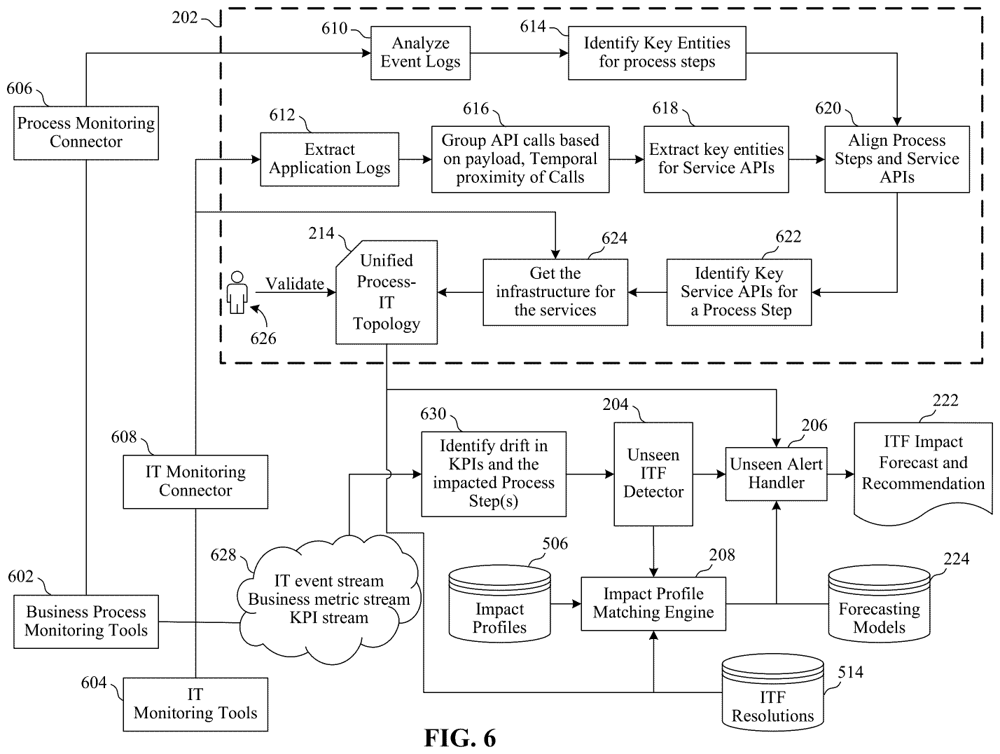

FIG. 6 illustrates an example of the unified process-IT topology generation as performed by unified topology generator 202 of ITF prediction framework 200. In the example of FIG. 6, unified topology generator 202 generates unified process-IT topology 214 with respect to a business process performed by an enterprise and supported by an IT infrastructure of the enterprise (FIG. 7). Illustratively, unified topology generator 202 communicatively couples via a wired or wireless connection to business process monitoring tools 602 and IT monitoring tools 604, though process monitoring connector 606 and IT monitoring connector 608, respectively. Referring additionally to FIG. 7, unified process-IT topology 214 is generated by unified topology generator 202 with respect to example process IT combination 700. Process IT combination 700 can model one or more real-life process, including various business processes. Process IT combination 700 illustratively includes modeled process 702. Modeled process 702 is supported by IT applications and services 704. IT applications and services 704 illustratively include order management application 706, inventory app 708, and invoice management app 710, each of which performs multiple services. IT applications and services 704 execute on IT infrastructure and platforms 712.

Referring still to FIG. 6, in block 610, unified topology generator 202 analyzes event logs generated by business process monitoring tools 602. Unified topology generator 202, in block 612, extracts application logs generated by IT monitoring tools 604. The actions in blocks 610 and 612 can be performed by unified topology generator 202 concurrently or at different times during the generative process. In block 614, unified topology generator 202 identifies key entities of process steps, the key entities uniquely identifying one or more properties of each service and whose values identify each service's type at run time. For a process step describing an activity, such as creating an order, for example, the key entity includes the words “create order” and the attribute values associated with this entity, recorded in the process log. Attributes correspond to the activity details, including a timestamp. For an API call (e.g. /api/v1/create_order), the key entity would be the phrase “create_order” and the payload will contain the order details including the timestamp. As such the key entities for service APIs are usually embedded within the function calls themselves, whereas the key entity for a process step, as recorded in the process logs, is usually found in the activity name column.

In block 616, unified topology generator 202 groups API calls from the extracted application logs based on temporal and/or semantic proximity to one another as indicated from the API calls' payloads and temporal proximity to one another. In block 618, unified topology generator 202 extracts key entities for service APIs.

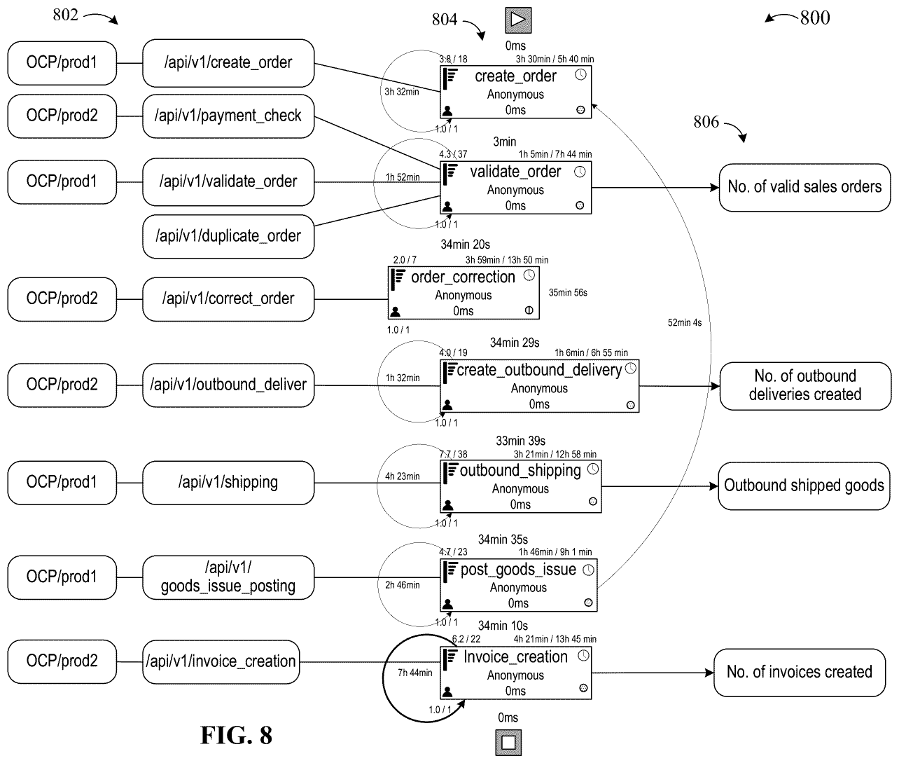

In block 620, unified topology generator 202, as described in the following paragraphs, aligns the process steps—place, validate, prepare, and ship order, followed by payment receipt—of modeled process 702 and service APIs of IT applications 704, 706, 708, and 710. In certain embodiments, the aligning is based on a mapping generated using the Hierarchical Dirichlet Gaussian Marked Hawkes Process described below. After identifying key service APIs for each process step in block 622, unified topology generator 202 retrieves the infrastructure for services in block 624. Having aligned and linked the process steps of modeled process 702 with the IT events, unified topology generator 202 generates unified process-IT topology 214. Referring additionally to FIG. 8, a portion 800 of unified process-IT topology 214 is illustrated in which IT system elements and IT system elements 802 are linked to process steps 804. Important KPIs 806 corresponding to business steps can be identified and linked to the IT system elements 802, which include API calls, for example. Optionally, the identification can be through a post-hoc validation by user 626.

In certain embodiments, the unified process-IT topology introduced herein implements a Hierarchical Dirichlet Gaussian Marked Hawkes Process (HD-GMHP). The HD-GMHP implemented by the unified process-IT topology, as introduced herein, models the triggering relationship between events thus identifying which preceding events trigger an occurrence of a current event. Thus, in the context of a process (e.g., business process), the HD-GMHP can model an event sequence in which a process step depends on one or more preceding steps. Using meta-information of events, such as location and keywords structured as feature vectors, the inventive arrangements can identify both IT and process events through event embedding techniques from the domain of process mining (e.g., process/suffix prediction). Using temporal characteristics in an event stream, the inventive arrangements can predict a likely process event based on a close temporal proximity of one or more related process events. The inventive arrangements can use the HD-GMHP for local clustering with respect to each event stream. This allows events in multiple local clusters from separate streams, which may by characterized by large time differences, to be represented in a single global cluster through a Hierarchical Dirichlet Process (HDP) that links each Gaussian Marked Hawkes Process (GMHP).

The process steps and IT events are two concurrent event streams. Aligning and linking process steps and API calls involves the above-described grouping of both. In one or more embodiments, unified topology generator 202 ensures a one-to-one correspondence between distinct groupings, or clusters, of process steps and IT events (e.g., API calls) by suitably modifying the sequential Monte Carlo sampling procedure of the HD-GMHP. The HD-GMHP, as implemented by unified topology generator 202, generates a single global cluster by only sampling events from two local clusters that are each from different event streams—an event stream of process steps and a stream of IT events (e.g., API calls). As implemented, the HD-GMHP does not assign a third cluster from either stream to the global cluster. In general, event embedding spaces are necessarily different for process steps and IT events (due to different terminologies). While this does not necessarily hinder unified topology generator 202's sampling of local clusters in each individual event stream (since each can be treated as a separate GMHP), it can be problematic for sampling the global clusters. The problem is solved in two different embodiments of unified topology generator 202.

In one embodiment, unified topology generator 202 prevents a flow of embedding information between local clusters in different streams and restricts sampling such that only the embedding information within the same stream is eligible. Nevertheless, unified topology generator 202 shares temporal information across the local clusters in different event streams during the sampling process. In the other, more complex embodiment, unified topology generator 202 uses a probabilistic model or deep learning neural network that links the two embedding spaces by learning a probabilistic mapping function that takes an embedding from one space as input and generates a probability distribution over embeddings in the other space as output. Unified topology generator 202 uses this mapping during the cluster sampling process for linking and aligning similar process steps and IT events.

Referring still to FIG. 6, with the creation of unified process-IT topology 214 by unified topology generator 202, an IT event stream, business metric steam, KPI stream, and/or other data stream received via communications network 628 can be processed by unseen ITF detector 204, unseen event handler 206, and impact profile matching engine 208 according to the procedures described above in connection with FIGS. 2-5. To maintain the accuracy of the ITF impact predictions and recommendations generated over time, drift identifier 210 in block 630 can identify KPI drift that can occur over time and can determine the impact with respect to any process step(s) whose performance is measured by an affected KPI. Based on the determination, unified process-IT topology 214 can be updated or revised by unified topology generator 202 in response to detected KPI drift.

For example, an enterprise that uses the modeled process 702 for placement, validation, preparation, and shipment of customer orders, may measure the percentage of payment receipts handled electronically by invoice management app 710. If over time a greater percentage of payments are handled online, a corresponding KPI measuring the percentage increases commensurately. The change (KPI impact) can affect, for example, operation of unseen ITF detector 204. ITF detector 204 can detect a possible IT failure that is otherwise unobserved by noting a greater-than-threshold in a corresponding KPI (FIG. 5). If the desired value of the KPI that measures the percentage of payments handled online by invoice management app 710 is not revised upward due to drift (increase in payments processed electronically), then a drop in the KPI due to a failure of invoice management app 710 may not be detected. A drop in the KPI relative to the pre-drift value may not be greater than the predetermined threshold (e.g., 20 percent drop). If the KPI has been revised upward to reflect the drift, a drop in the KPI relative to the now-higher value is more likely greater than the threshold and is thus recognized by unseen ITF detector 204 as an indication of a possible IT failure. Detecting the KPI impact (drop in percentage of payments processed electronically) invokes the operations of the other ITF impact prediction framework 200 elements, as already described.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting, with computer hardware, a computer-generated indication of an information technology (IT) failure affecting a process performed by an IT system;
determining, with the computer hardware, that the computer-generated indication corresponds to a previously unseen IT failure;
mapping, with the computer hardware executing an unseen event handler, the previously unseen IT failure to a previously seen IT failure based on a similarity score generated by a computer-implemented similarity scorer;
generating, with a machine learning model, an IT failure impact prediction and recommendation based on the mapping, wherein the machine learning model is based on a unified process-IT topology; and
outputting, with the computer hardware, the IT failure prediction and recommendation.

2. The method of claim 1, further comprising:
generating the unified process-IT topology by a generative process including:
determining key entities of a plurality of steps of the process performed by the IT system;
grouping a plurality of application program interface (API) calls based on payload and temporal proximities of the API calls, and for corresponding service APIs, extracting key entities;
aligning the plurality of steps and service APIs;
determining key service APIs for the process steps; and
generating the unified process-IT topology based on a retrieved infrastructure of the service APIs.

3. The method of claim 1, further comprising:
extracting a resolution history corresponding to the previously seen IT failure; and
including the resolution history in the IT failure prediction and recommendation.

4. The method of claim 1, wherein the computer-generated indication is a previously unseen IT alert, and wherein the generating includes:
responsive to determining that the previously unseen IT alert maps to a previously seen IT alert from a current environment, extracting parameters of the previously seen IT alert; and
inputting the parameters to the machine learning for generating the IT failure impact prediction based on the parameters.

5. The method of claim 1, wherein the computer-generated indication is a previously unseen IT alert, and wherein the generating includes:
responsive to determining that the previously unseen IT alert maps to a previously seen IT alert from an external environment, generating an estimated severity of impact on the IT system; and
generating a warning of the estimated severity to include as part of the IT failure prediction and recommendation.

6. The method of claim 1, wherein the computer-generated indication is change in a KPI associated with the process, and wherein the mapping includes:
performing a database search to match the change in the KPI with an existing impact profile corresponding to the previously seen IT failure, wherein the matching is based on statistical correlation; and
wherein the IT failure prediction and recommendation corresponds to an impact assessment for the previously seen IT failure.

7. The method of claim 1, further comprising:
updating the machine learning model based on the mapping of the previously unseen IT failure to a previously seen IT failure.

8. A system, comprising:
A processor configured to initiate operations including:
detecting a computer-generated indication of an information technology (IT) failure affecting a process performed by an IT system;
determining that the computer-generated indication corresponds to a previously unseen IT failure;
mapping the previously unseen IT failure to a previously seen IT failure based on a similarity score;
generating, with a machine learning model, an IT failure impact prediction and recommendation based on the mapping, wherein the machine learning model is based on a unified process-IT topology; and
outputting the IT failure prediction and recommendation.

9. The system of claim 8, wherein the processor is configured to initiate operations further including:
generating the unified process-IT topology by a generative process including:
determining key entities of a plurality of steps of the process performed by the IT system;
grouping a plurality of application program interface (API) calls based on payload and temporal proximities of the API calls, and for corresponding service APIs, extracting key entities;
aligning the plurality of steps and service APIs;
determining key service APIs for the process steps; and
generating the unified process-IT topology based on a retrieved infrastructure of the service APIs.

10. The system of claim 8, wherein the processor is configured to initiate operations further including:
extracting a resolution history corresponding to the previously seen IT failure; and
including the resolution history in the IT failure prediction and recommendation.

11. The system of claim 8, wherein the computer-generated indication is a previously unseen IT alert, and wherein the generating includes:
responsive to determining that the previously unseen IT alert maps to a previously seen IT alert from a current environment, extracting parameters of the previously seen IT alert; and
inputting the parameters to the machine learning for generating the IT failure impact prediction based on the parameters.

12. The system of claim 8, wherein the computer-generated indication is a previously unseen IT alert, and wherein the generating includes:
responsive to determining that the previously unseen IT alert maps to a previously seen IT alert from an external environment, generating an estimated severity of impact on the IT system; and
generating a warning of the estimated severity to include as part of the IT failure prediction and recommendation.

13. The system of claim 8, wherein the computer-generated indication is change in a KPI associated with the process, and wherein the mapping includes:
performing a database search to match the change in the KPI with an existing impact profile corresponding to the previously seen IT failure, wherein the matching is based on statistical correlation; and
wherein the IT failure prediction and recommendation corresponds to an impact assessment for the previously seen IT failure.

14. A computer program product, the computer program product comprising:
one or more computer-readable storage media and program instructions collectively stored on the one or more computer-readable storage media, the program instructions executable by a processor to cause the processor to initiate operations including:
detecting a computer-generated indication of an information technology (IT) failure affecting a process performed by an IT system;
determining that the computer-generated indication corresponds to a previously unseen IT failure;
mapping the previously unseen IT failure to a previously seen IT failure based on a similarity score;
generating, with a machine learning model, an IT failure impact prediction and recommendation based on the mapping, wherein the machine learning model is based on a unified process-IT topology; and
outputting the IT failure prediction and recommendation.

15. The computer program product of claim 14, wherein the program instructions are executable by the processor to cause the processor to initiate operations further including:
generating the unified process-IT topology by a generative process including:
determining key entities of a plurality of steps of the process performed by the IT system;
grouping a plurality of application program interface (API) calls based on payload and temporal proximities of the API calls, and for corresponding service APIs, extracting key entities;
aligning the plurality of steps and service APIs;
determining key service APIs for the process steps; and
generating the unified process-IT topology based on a retrieved infrastructure of the service APIs.

16. The computer program product of claim 14, wherein the program instructions are executable by the processor to cause the processor to initiate operations further including:
extracting a resolution history corresponding to the previously seen IT failure; and
including the resolution history in the IT failure prediction and recommendation.

17. The computer program product of claim 14, wherein the computer-generated indication is a previously unseen IT alert, and wherein the generating includes:
responsive to determining that the previously unseen IT alert maps to a previously seen IT alert from a current environment, extracting parameters of the previously seen IT alert; and
inputting the parameters to the machine learning for generating the IT failure impact prediction based on the parameters.

18. The computer program product of claim 14, wherein the computer-generated indication is a previously unseen IT alert, and wherein the generating includes:
responsive to determining that the previously unseen IT alert maps to a previously seen IT alert from an external environment, generating an estimated severity of impact on the IT system; and
generating a warning of the estimated severity to include as part of the IT failure prediction and recommendation.

19. The computer program product of claim 14, wherein the computer-generated indication is change in a KPI associated with the process, and wherein the mapping includes:
performing a database search to match the change in the KPI with an existing impact profile corresponding to the previously seen IT failure, wherein the matching is based on statistical correlation; and
wherein the IT failure prediction and recommendation corresponds to an impact assessment for the previously seen IT failure.

20. The computer program product of claim 14, further comprising:
updating the machine learning model based on the mapping of the previously unseen IT failure to a previously seen IT failure.
